(19) United States
(12) Patent Application Publication
(10) Pub. No.: US 2020/0132500 A1
(43) Pub. Date: Apr. 30, 2020

(54) NEW ROAD DEDUCATION ASSISTANCE DEVICE, NEW ROAD DEDUCATION ASSISTANCE METHOD, AND COMPUTER PROGRAM PRODUCT

(71) Applicant: TOYOTA MAPMASTER INCORPORATED, Nagoya-shi, Aichi-ken (JP)

(72) Inventor: Yumiko Yamashita, Nagoya-shi, Aichi-ken (JP)

(21) Appl. No.: 16/629,181

(22) PCT Filed: Jul. 20, 2017
(86) PCT No.: PCT/JP2017/026203

§ 371 Date: Jan. 7, 2020

(51) Int. Cl. G01C 21/36; H04W 4/029; H04W 4/024; H04W 4/02; H04W 4/48; G06F 16/29; G01C 21/34; G01C 21/32

(52) U.S. Cl. CPC G01C 21/3676; H04W 4/029; H04W 4/024; G01C 21/32; H04W 4/48; G06F 16/29; G01C 21/3492; H04W 4/027

(57) ABSTRACT

Provided is a new road deducation assistance device, a new road deducation assistance method, a computer program, a computer program product, and a recording medium having the computer program recorded therein. This new road deducation assistance method involves: a probe information storage unit that stores sets of probe information including terminal ID information, date information, and positional information of a terminal device, acquired from the terminal device that has a positional information acquisition function and that is mountable to a vehicle; and a map database that stores sets of map information including information about links, wherein sets of probe information including speed information of a prescribed value or higher and not matching the links are extracted as target probe information sets from among the stored sets of probe information, and the extracted target probe information sets are superimposed on the map information to be displayed.

### CROSS-REFERENCE TO RELATED APPLICATIONS

This application claims priority to PCT Application No. PCT/JP2017/026203, having a filing date of Jul. 20, 2017, the entire contents of which are hereby incorporated by reference.

### FIELD OF TECHNOLOGY

The following relates to a new road deducation assistance apparatus, a new road deducation assistance method, a computer program, a computer program product, and a recording medium recording a computer program.

### BACKGROUND

The map data stored in a mobile terminal device such as an in-vehicle navigation device or a smart-phone is required to be updated according to the latest road conditions such as the opening of a new road in order to maintain the freshness of the map. However, it is a great effort to know where and when a new road will be opened by daily field surveys.

Current technology discloses a technology in which a traveling path of a vehicle is specified based on probe information pieces, a map matching is performed by correcting a position of the vehicle to a position on a map when a link exists within a position error range of the vehicle on the traveling path, and a traveling path that could not be matched with the links is determined as a new road.

### SUMMARY

An aspect relates to the deducation of a new road using probe information pieces. As a result, the inventors conceived an approach in which, when a predetermined number or more of target probe information pieces having the same terminal ID information and being continuous in time exist among the probe information pieces not matched with the links on the map and having a velocity equal to or higher than a predetermined value, the target probe information pieces having the predetermined number or more are selected as the group of the target probe information pieces, and the selected group of the target probe information pieces are superimposed on the map. The group of the target probe information pieces having the above features will suggest a high possibility that a new road not reflected on the map has been opened, and the labor of the investigation can be reduced by making such a path with a high possibility as a target of the field survey.

The present disclosure is made in order to achieve the above object, and a new road deducation assistance apparatus according to at least some aspects of the present disclosure is defined as follows.

The new road deducation assistance apparatus according to the first aspect includes:

a probe information storage unit for storing probe information pieces acquired from a terminal device mountable on a vehicle and having a position information acquisition function, the probe information pieces including position information and date/time information of the terminal device and terminal ID information capable of identifying the terminal device;

a map database for storing map information including information of links;

an extraction unit for extracting, from the probe information pieces stored in the probe information storage unit, probe information pieces which are not matched with the links and whose velocity information indicates a predetermined value or more as target probe information pieces; and

a display unit for superimposing and displaying the extracted target probe information pieces on the map information,

the new road deducation assistance apparatus further including:

a selection unit for selecting, from the extracted target probe information pieces, a group of the target probe information pieces having the same terminal ID information and having a predetermined number or more of target probe information pieces being continuous in time,

wherein the display unit superimposes and displays the selected group of the target probe information pieces on the map information.

According to the new road deducation assistance apparatus of the first aspect defined above, among target probe information pieces which are not matched with links and has velocity information of a predetermined value or more, target probe information pieces having the same terminal ID information and being continuous in time and having a predetermined number or more of continuous target probe information pieces are selected as a group of the target probe information pieces, and the selected group of the target probe information pieces are superimposed on a map. If more than a predetermined number of probe information pieces obtained from the in-vehicle navigation device or the like having the same terminal ID information continue in time, it is highly likely that the group of the target probe information pieces have been obtained from the in-vehicle navigation device traveling on a new road. The number of continuous probe information pieces may be 8 or more, preferably 10 or more, from the viewpoint of improving the accuracy of new road deducation. The number may vary depending on road attributes such as road type and the number of lanes of the new road to be deduced. For example, when a new highway is deduced, the continuous number can be increased to 15 or more because a highway has a long distance and the velocity of a vehicle is high.

The probe information pieces further include information relating to an acquisition interval of the position information, and the predetermined number may be determined based on the acquisition interval information and the velocity information of the probe information pieces (the second aspect). As described above, the continuous number of the probe information pieces may be made dependent on the acquisition interval and the velocity of the position information. Furthermore, the continuous number may be determined so as to correspond to continuous driving of 100 m or more.

The new road deducation assistance apparatus defined in the third aspect is defined as follows.

In the new road deducation assistance apparatus according to the first or second aspect,

all or part of the probe information pieces are associated with a travel image data, and the new road deducation assistance apparatus further includes:

a specifying unit for specifying, from the selected group of the target probe information pieces, a group of the target probe information pieces associated with the travel image data;

a determination unit for determining, based on the travel image data associated with the group of the specified target probe information pieces, whether another vehicle has stopped in the vicinity of the group of the specified target probe information pieces; and

a filter unit for removing the group of the specified target probe information pieces for which it is determined that the other vehicle has stopped,

wherein the display unit superimposes and displays the group of the specified target probe information pieces except for the group of the removed target probe information pieces. According to the new road deducation assistance apparatus of the third aspect defined above, the group of the target probe information pieces located at a place other than new roads, such as a parking lot, are removed from the selected group of the target probe information pieces, and the selected group of the target probe information pieces can be superimposed and displayed. In other words, when it is determined that another vehicle positioned around the group of the target probe information pieces is stopped based on the travel image data of the group of the target probe information pieces, it is deduced that the group of the target probe information pieces are unlikely to be traveling on a new road, and the group of the target probe information pieces are removed from the display object. Thus, the deducation assistance of the new road can be performed with higher accuracy.

The new road deducation assistance apparatus defined in the fourth aspect is defined as follows.

In the new road deducation assistance apparatus according to the first or second aspect,

all or part of the probe information pieces are associated with an inter-vehicle communication data, and the new road deducation assistance apparatus further includes:

a specifying unit for specifying, from the group of the selected target probe information pieces, a group of the target probe information pieces associated with the inter-vehicle communication data;

a determination unit for determining, based on the inter-vehicle communication data associated with the group of the specified target probe information pieces, whether another vehicle has stopped in the vicinity of the group of the specified target probe information pieces; and

a filter unit for removing the group of the specified target probe information pieces for which it is determined that the other vehicle has stopped,

wherein the display unit superimposes and displays the group of the specified target probe information pieces except for the group of the removed target probe information pieces. According to the new road deducation assistance apparatus of the fourth aspect defined above, based on the inter-vehicle communication data of the selected group of the target probe information pieces, it is deduced that the group of the target probe information pieces for which it is determined that another vehicle positioned around the group of the target probe information pieces is stopped are unlikely to be traveling on a new road, and the group of the target probe information pieces are removed from the superimposed display. Thus, the deducation assistance of the new road can be performed with higher accuracy.

The new road deducation assistance apparatus defined in the fifth aspect is defined as follows.

In the new road deducation assistance apparatus according to the first or second aspect,

the probe information pieces further include the velocity information, and the new road deducation assistance apparatus further includes:

a designation unit for designating probe information pieces of another vehicle present at the same time in the vicinity of the group of the selected target probe information pieces;

a determination unit for determining whether the other vehicle has stopped based on the velocity information of the designated probe information pieces; and

a filter unit for removing the group of the selected target probe information pieces for which it is determined that the other vehicle has stopped,

wherein the display unit superimposes and displays the selected group of the target probe information pieces except for the group of the removed target probe information pieces. According to the new road deducation assistance apparatus of the fifth aspect defined above, based on the velocity information of another vehicle positioned around the selected group of the target probe information pieces, it is deduced that the group of the target probe information pieces for which the other vehicle is determined to be stopped are unlikely to be traveling on a new road and are removed from the superimposed display. Thus, the deducation assistance of the new road can be performed with higher accuracy.

The new road deducation assistance apparatus defined in the sixth aspect is defined as follows.

In the new road deducation assistance apparatus according to the first or second aspect, the new road deducation assistance apparatus includes:

a probe information storage unit for storing probe information pieces acquired from a terminal device mountable on a vehicle and having a position information acquisition function, the probe information pieces including position information and date/time information of the terminal device and terminal ID information capable of identifying the terminal device and associated with travel image data;

a map database for storing map information including information of links;

an extraction unit for extracting, from the probe information pieces stored in the probe information storage unit, probe information pieces which are not matched with the links and whose velocity information indicates a predetermined value or more as target probe information pieces; and

a display unit for superimposing and displaying the extracted target probe information pieces on the map information,

and the new road deducation assistance apparatus further includes:

a determination unit for determining, based on the travel image data associated with the extracted target probe information pieces, whether another vehicle has stopped in the vicinity of the extracted target probe information pieces; and

a filter unit for removing the extracted target probe information pieces for which it is determined that the other vehicle has stopped,

wherein the display unit superimposes and displays the extracted target probe information pieces except for the removed target probe information pieces.

According to the new road deducation assistance apparatus of the sixth aspect defined above, when it is determined that another vehicle positioned around the target probe information pieces is stopped based on the travel image data of the target probe information pieces which are not matched with the links and whose velocity information indicates a predetermined value or more, it is deduced that the target probe information pieces are unlikely to be traveling on a new road, and the target probe information pieces are removed from the display object. Thus, the deducation assistance of the new road can be performed with higher accuracy.

The new road deducation assistance apparatus defined in the seventh aspect is defined as follows.

In the new road deducation assistance apparatus according to the first or second aspect, the new road deducation assistance apparatus includes:

a probe information storage unit for storing probe information pieces acquired from a terminal device mountable on a vehicle and having a position information acquisition function, the probe information pieces including position information and date/time information of the terminal device and terminal ID information capable of identifying the terminal device and associated with inter-vehicle communication data;

a map database for storing map information including information of links;

an extraction unit for extracting, from the probe information pieces stored in the probe information storage unit, probe information pieces which are not matched with the links and whose velocity information indicates a predetermined value or more as target probe information pieces; and

a display unit for superimposing and displaying the extracted target probe information pieces on the map information,

and the new road deducation assistance apparatus further includes:

a determination unit for determining, based on the inter-vehicle communication data associated with the extracted target probe information pieces, whether another vehicle has stopped in the vicinity of the extracted target probe information pieces; and

a filter unit for removing the extracted target probe information pieces for which it is determined that the other vehicle has stopped,

wherein the display unit superimposes and displays the extracted target probe information pieces except for the removed target probe information pieces.

According to the new road deducation assistance apparatus of the seventh aspect defined above, when it is determined that another vehicle positioned around the vehicle is stopped based on inter-vehicle communication data of the target probe information pieces which are not matched with the links and whose velocity information indicates a predetermined value or more, it is deduced that the target probe information pieces are unlikely to be traveling on a new road, and the target probe information pieces are removed from the display target. Thus, the deducation assistance of the new road can be performed with higher accuracy.

The new road deducation assistance apparatus defined in the eighth aspect is defined as follows. The new road deducation assistance apparatus includes:

a probe information storage unit for storing probe information pieces acquired from a terminal device mountable on a vehicle and having a position information acquisition function, the probe information pieces including position information and date/time information of the terminal device, terminal ID information capable of identifying the terminal device, and velocity information;

a map database for storing map information including information of links;

an extraction unit for extracting, from the probe information pieces stored in the probe information storage unit, probe information pieces which are not matched with the links and whose velocity information indicates a predetermined value or more as target probe information pieces; and

a display unit for superimposing and displaying the extracted target probe information pieces on the map information,

and the new road deducation assistance apparatus further includes:

a designation unit for designating probe information pieces of another vehicle present at the same time in the vicinity of the extracted target probe information pieces;

a determination unit for determining whether the other vehicle has stopped based on the velocity information of the designated probe information pieces; and

a filter unit for removing the extracted target probe information pieces for which it is determined that the other vehicle has stopped,

wherein the display unit superimposes and displays the extracted target probe information pieces except for the removed target probe information pieces.

According to the new road deducation assistance apparatus of the eighth aspect defined above, based on the velocity information of another vehicle positioned around the target probe information pieces which are not matched with the links and whose velocity information indicates equal to or higher than a predetermined value, it is deduced that the target probe information pieces for which the other vehicle is determined to be stopped are unlikely to be traveling on a new road and are removed from the superimposed display. Thus, the deducation assistance of the new road can be performed with higher accuracy.

The new road deducation assistance method according to the ninth aspect includes:

a probe information storing step of storing, in a probe information storing unit, probe information pieces acquired from a terminal device mountable on a vehicle and having a position information acquisition function, the probe information pieces including position information and date/time information of the terminal device and terminal ID information capable of identifying the terminal device;

a storing step of storing map information including information of links in a map database;

an extracting step in which an extraction unit extracts, from the probe information pieces stored in the probe information storage unit, probe information pieces which are not matched with the links and whose velocity information indicates a predetermined value or more as target probe information pieces; and

a displaying step in which the display unit superimposes and displays the extracted target probe information pieces on the map information,

and the new road deducation assistance method further includes:

a selecting step in which a selection unit selects, from the extracted target probe information pieces, a group of the target probe information pieces having the same terminal ID information and having a predetermined number or more of target probe information pieces being continuous in time,

wherein in the displaying step, the group of the selected target probe information pieces are superimposed and displayed on the map information.

The new road deducation assistance method of the ninth aspect defined above has the same effect as that of the first aspect.

The new road deducation assistance method according to the tenth aspect is defined as follows.

In the new road deducation assistance method according to the ninth aspect,

the probe information pieces further include information relating to an acquisition interval of the position information, and

the predetermined number is determined based on the acquisition interval information and the velocity information of the probe information pieces.

The new road deducation assistance method of the tenth aspect defined above has the same effect as that of the second aspect.

The new road deducation assistance method according to the eleventh aspect is defined as follows.

In the new road deducation assistance method according to the ninth or tenth aspect,

all or part of the probe information pieces are associated with a travel image data, and the new road deducation assistance method further includes:

a specifying step in which a specifying unit specifies, from the selected group of the target probe information pieces, a group of the target probe information pieces associated with the travel image data;

a determining step in which a determination unit determines, based on the travel image data associated with the group of the specified target probe information pieces, whether another vehicle has stopped in the vicinity of the group of the specified target probe information pieces; and

a filtering step in which a filter unit removes the group of the specified target probe information pieces for which it is determined that the other vehicle has stopped,

wherein, in the displaying step, the group of the specified target probe information pieces except for the group of the removed target probe information pieces are superimposed and displayed on the map information.

The new road deducation assistance method of the eleventh aspect defined above has the same effect as that of the third aspect.

The new road deducation assistance method according to the twelfth aspect is defined as follows.

In the new road deducation assistance method according to the ninth or tenth aspect,

all or part of the probe information pieces are associated with an inter-vehicle communication data, and the new road deducation assistance method further includes:

a specifying step in which a specifying unit specifies, from the group of the selected target probe information pieces, a group of the target probe information pieces associated with the inter-vehicle communication data;

a determining step in which a determination unit determines, based on the inter-vehicle communication data associated with the group of the specified target probe information pieces, whether another vehicle has stopped in the vicinity of the group of the specified target probe information pieces; and

a filtering step in which a filter unit removes the specified group of the target probe information pieces determined that the other vehicle has stopped;

wherein, in the displaying step, the group of the specified target probe information pieces except for the group of the removed target probe information pieces are superimposed and displayed on the map information.

The new road deducation assistance method of the twelfth aspect defined above has the same effect as that of the fourth aspect.

The new road deducation assistance method according to the thirteenth aspect is defined as follows.

In the new road deducation assistance method according to the ninth or tenth aspect,

the probe information pieces further include the velocity information, and the new road deducation assistance method further includes:

a designating step in which a designation unit designates probe information pieces of another vehicle present at the same time in the vicinity of the group of the selected target probe information pieces;

a determining step in which a determination unit determines whether the other vehicle has stopped based on the velocity information of the designated probe information pieces; and

a filtering step in which a filter unit removes the group of the selected target probe information pieces for which it is determined that the other vehicle has stopped,

wherein, in the displaying step, the group of the selected target probe information pieces except for the group of the removed target probe information pieces are superimposed and displayed on the map information.

The new road deducation assistance method of the thirteenth aspect defined above has the same effect as that of the fifth aspect.

The new road deducation assistance method according to the fourteenth aspect includes:

a probe information storing step of storing, in a probe information storing unit, probe information pieces acquired from a terminal device mountable on a vehicle and having a position information acquisition function, the probe information pieces including position information and date/time information of the terminal device and terminal ID information capable of identifying the terminal device and associated with travel image data;

a storing step of storing map information including information of links in a map database;

an extracting step in which an extraction unit extracts, from the probe information pieces stored in the probe information storage unit, probe information pieces which are not matched with the links and whose velocity information indicates a predetermined value or more as target probe information pieces; and

a displaying step in which the display unit superimposes and displays the extracted target probe information pieces on the map information,

and a new road deducation assistance method further includes:

a determining step in which a determination unit determines, based on the travel image data associated with the extracted target probe information pieces, whether another vehicle has stopped in the vicinity of the extracted target probe information pieces; and

a filtering step in which a filter unit removes the extracted target probe information pieces for which it is determined that the other vehicle has stopped,

wherein, in the displaying step, the extracted target probe information pieces except for the removed target probe information pieces are superimposed and displayed.

The new road deducation assistance method of the fourteenth aspect defined above has the same effect as that of the sixth aspect.

The new road deducation assistance method according to the fifteenth aspect includes:

a probe information storing step of storing, in a probe information storing unit, probe information pieces acquired from a terminal device mountable on a vehicle and having a position information acquisition function, the probe information pieces including position information and date/time information of the terminal device and terminal ID information capable of identifying the terminal device and associated with inter-vehicle communication data;

a storing step of storing map information including information of links in a map database;

an extracting step in which an extraction unit extracts, from the probe information pieces stored in the probe information storage unit, probe information pieces which are not matched with the links and whose velocity information indicates a predetermined value or more as target probe information pieces; and

a displaying step in which the display unit superimposes and displays the extracted target probe information pieces on the map information,

and the new road deducation assistance method further includes:

a determining step in which a determination unit determines, based on the inter-vehicle communication data associated with the extracted target probe information pieces, whether another vehicle has stopped in the vicinity of the extracted target probe information pieces; and

a filtering step in which a filter unit removes the extracted target probe information pieces for which it is determined that the other vehicle has stopped,

wherein, in the displaying step, the extracted target probe information pieces except for the removed target probe information pieces are superimposed and displayed.

The new road deducation assistance method of the fifteenth aspect as define above has the same effect as that of the seventh aspect.

The new road deducation assistance method according to the sixteenth aspect includes:

a probe information storing step of storing, in a probe information storing unit, probe information pieces acquired from a terminal device mountable on a vehicle and having a position information acquisition function, the probe information pieces including position information and date/time information of the terminal device, terminal ID information capable of identifying the terminal device, and velocity information;

a storing step of storing map information including information of links in a map database;

an extracting step in which an extraction unit extracts, from the probe information pieces stored in the probe information storage unit, probe information pieces which are not matched with the links and whose velocity information indicates a predetermined value or more as target probe information pieces; and

a displaying step in which the display unit superimposes and displays the extracted target probe information pieces on the map information,

and the new road deducation assistance method further includes:

a designating step in which a designation unit designates probe information pieces of another vehicle present at the same time in the vicinity of the extracted target probe information pieces;

a determining step in which a determination unit determines whether the other vehicle has stopped based on the velocity information of the designated probe information pieces; and

a filtering step in which a filter unit removes the extracted target probe information pieces for which it is determined that the other vehicle has stopped,

wherein, in the displaying step, the extracted target probe information pieces except for the removed target probe information pieces are superimposed and displayed.

The new road deducation assistance method of the sixteenth aspect defined above has the same effect as that of the eighth aspect.

The computer program according to the seventeenth aspect causes a computer to function as:

a probe information storing means for storing, in a probe information storing unit, probe information pieces acquired from a terminal device mountable on a vehicle and having a position information acquisition function, the probe information pieces including position information and date/time information of the terminal device and terminal ID information capable of identifying the terminal device;

a storing means for storing map information including information of links in a map database;

an extracting means for extracting, from the probe information pieces stored in the probe information storage unit, probe information pieces which are not matched with the links and whose velocity information indicates a predetermined value or more as target probe information pieces; and

a displaying means for superimposing and displaying the extracted target probe information pieces on the map information, and

the computer program further causes the computer to function as:

a selecting means for selecting, from the extracted target probe information pieces, a group of the target probe information pieces having the same terminal ID information and having a predetermined number or more of target probe information pieces being continuous in time,

wherein the displaying means superimposes and displays the selected group of the target probe information pieces on the map information.

The computer program according to the seventeenth aspect defined above has the same effect as that of the first aspect.

The computer program according to the eighteenth aspect is defined as follows.

In the computer program according to the seventeenth aspect,

the probe information pieces further include information relating to an acquisition interval of the position information, and

the predetermined number is determined based on the acquisition interval information and the velocity information of the probe information pieces.

The computer program of the eighteenth aspect defined above has the same effect as that of the second aspect.

The computer program according to the nineteenth aspect is defined as follows.

In the computer program according to the seventeenth or eighteenth aspect,

all or part of the probe information pieces are associated with a travel image data, and

the computer program further causes the computer to function as:

a specifying means for specifying, from the selected group of the target probe information pieces, a group of the target probe information pieces associated with the travel image data;

a determining means for determining, based on the travel image data associated with the group of the specified target probe information pieces, whether another vehicle has stopped in the vicinity of the group of the specified target probe information pieces; and

a filtering means for removing the group of the specified target probe information pieces for which it is determined that the other vehicle has stopped,

wherein the displaying means superimposes and displays the group of the specified target probe information pieces except for the group of the removed target probe information pieces.

The computer program of the nineteenth aspect defined above has the same effect as that of the third aspect.

The computer program according to the twentieth aspect is defined as follows.

In the computer program according to the seventeenth or eighteenth aspect,

all or part of the probe information pieces are associated with an inter-vehicle communication data, and

the computer program further causes the computer to function as:

a specifying means for specifying, from the group of the selected target probe information pieces, a group of the target probe information pieces associated with the inter-vehicle communication data;

a determining means for determining, based on the inter-vehicle communication data associated with the group of the specified target probe information pieces, whether another vehicle has stopped in the vicinity of the group of the specified target probe information pieces; and

a filtering means for removing the group of the specified target probe information pieces for which it is determined that the other vehicle has stopped,

wherein the displaying means superimposes and displays the group of the specified target probe information pieces except for the group of the removed target probe information pieces.

The computer program of the twentieth aspect defined above has the same effect as that of the fourth aspect.

The computer program according to the twenty-first aspect is defined as follows.

In the computer program according to the seventeenth or eighteenth aspect,

the probe information pieces further include the velocity information, and

the computer program further causes the computer to function as:

a designating means for designating probe information pieces of another vehicle present at the same time in the vicinity of the group of the selected target probe information pieces;

a determining means for determining whether the other vehicle has stopped based on the velocity information of the designated probe information pieces; and

a filtering means for removing the group of the selected target probe information pieces for which it is determined that the other vehicle has stopped,

wherein the displaying means superimposes and displays the selected group of the target probe information pieces except for the group of the removed target probe information pieces.

The computer program of the twenty-first aspect defined above has the same effect as that of the fifth aspect.

The computer program defined in the twenty-second aspect causes a computer to function as:

a probe information storing means for storing, in a probe information storing unit, probe information pieces acquired from a terminal device mountable on a vehicle and having a position information acquisition function, the probe information pieces including position information and date/time information of the terminal device and terminal ID information capable of identifying the terminal device and associated with travel image data;

a storing means for storing map information including information of links in a map database;

an extracting means for extracting, from the probe information pieces stored in the probe information storage unit, probe information pieces which are not matched with the links and whose velocity information indicates a predetermined value or more as target probe information pieces; and

a displaying means for superimposing and displaying the extracted target probe information pieces on the map information, and

the computer program further causes the computer to function as:

a determining means for determining, based on the travel image data associated with the extracted target probe information pieces, whether another vehicle has stopped in the vicinity of the extracted target probe information pieces; and

a filtering means for removing the extracted target probe information pieces for which it is determined that the other vehicle has stopped,

wherein the displaying means superimposes and displays the extracted target probe information pieces except for the removed target probe information pieces.

The computer program of the twenty-second aspect defined above has the same effect as that of the sixth aspect.

The computer program according to the twenty-third aspect causes a computer to function as:

a probe information storing means for storing, in a probe information storing unit, probe information pieces acquired from a terminal device mountable on a vehicle and having a position information acquisition function, the probe information pieces including position information and date/time information of the terminal device and terminal ID information capable of identifying the terminal device and associated with inter-vehicle communication data;

a storing means for storing map information including information of links in a map database;

an extracting means for extracting, from the probe information pieces stored in the probe information storage unit, probe information pieces which are not matched with the links and whose velocity information indicates a predetermined value or more as target probe information pieces; and

a displaying means for superimposing and displaying the extracted target probe information pieces on the map information, and

the computer program further causes the computer to function as:

a determining means for determining, based on the inter-vehicle communication data associated with the extracted target probe information pieces, whether another vehicle has stopped in the vicinity of the extracted target probe information pieces; and

a filtering means for removing the extracted target probe information pieces for which it is determined that the other vehicle has stopped,

wherein the displaying means superimposes and displays the extracted target probe information pieces except for the removed target probe information pieces.

The computer program of the twenty-third aspect defined above has the same effect as that of the seventh aspect.

The computer program according to the twenty-fourth aspect causes a computer to function as:

a probe information storing means for storing, in a probe information storing unit, probe information pieces acquired from a terminal device mountable on a vehicle and having a position information acquisition function, the probe information pieces including position information and date/time information of the terminal device, terminal ID information capable of identifying the terminal device, and velocity information;

a storing means for storing map information including information of links in a map database;

an extracting means for extracting, from the probe information pieces stored in the probe information storage unit, probe information pieces which are not matched with the links and whose velocity information indicates a predetermined value or more as target probe information pieces; and

a displaying means for superimposing and displaying the extracted target probe information pieces on the map information,

the computer program further causes the computer to function as:

a designating means for designating probe information pieces of another vehicle present at the same time in the vicinity of the extracted target probe information pieces;

a determining means for determining whether the other vehicle has stopped based on the velocity information of the designated probe information pieces; and

a filtering means for removing the extracted target probe information pieces for which it is determined that the other vehicle has stopped,

wherein the displaying means superimposes and displays the extracted target probe information pieces except for the removed target probe information pieces.

The computer program of the twenty-fourth aspect defined above has the same effect as that of the eighth aspect.

The twenty fifth aspect provides a recording medium on which the computer program defined in any of the seventeenth to twenty-fourth aspects is recorded.

Another aspect is a computer program product (non-transitory computer readable storage medium having instructions, which when executed by a processor, perform actions). The computer program product comprises a computer readable hardware storage device having computer readable program code stored therein, the program code executable by a processor of a computer system to implement a method of new road deducation assistance in accordance with embodiments disclosed herein.

### BRIEF DESCRIPTION

Some of the embodiments will be described in detail, with reference to the following figures, wherein like designations denote like members, wherein:

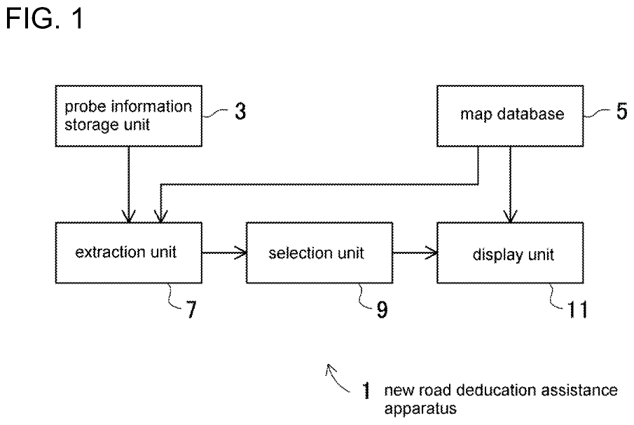

FIG. 1 is a block diagram schematically showing a configuration of a new road deducation assistance apparatus, according to a first embodiment of the present invention;

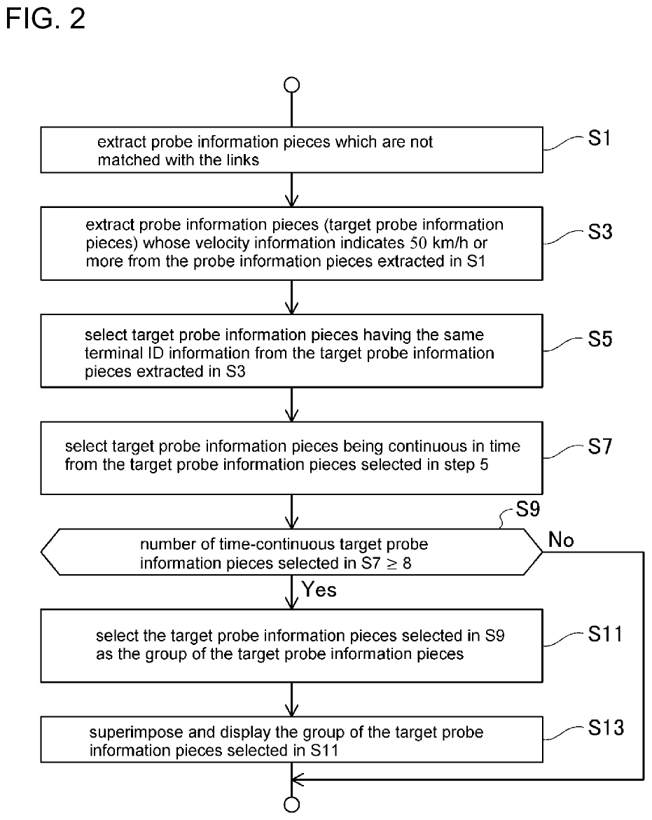

FIG. 2 is a flowchart showing an example of a new road deducation assistance method implemented by the new road deducation assistance apparatus, according to the first embodiment of the present invention;

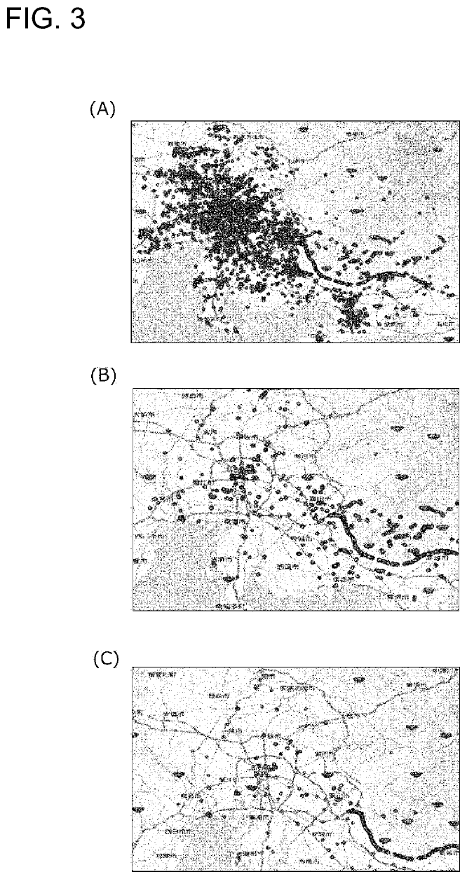

FIG. 3(A) shows a schematic diagram in which probe information pieces extracted in a step are plotted on a map;

FIG. 3(B) shows a schematic diagram in which probe information pieces extracted in another step are plotted on a map;

FIG. 3(C) shows a schematic diagram in which target probe information pieces selected in another step is superimposed on a map;

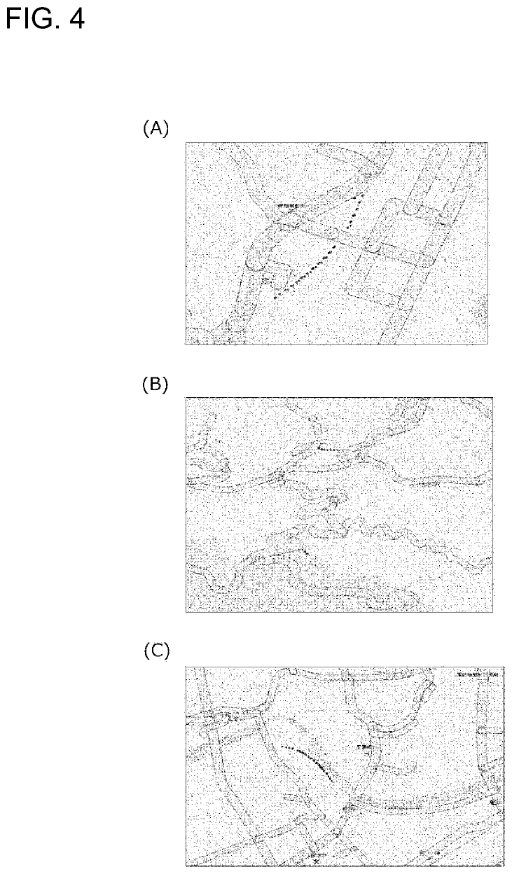

FIG. 4(A) is a schematic diagram showing a first example of the group of the target probe information pieces superimposed on a map;

FIG. 4(B) is a schematic diagram showing a first example of the group of the target probe information pieces superimposed on a map;

FIG. 4(C) is a schematic diagram showing a first example of the group of the target probe information pieces superimposed on a map;

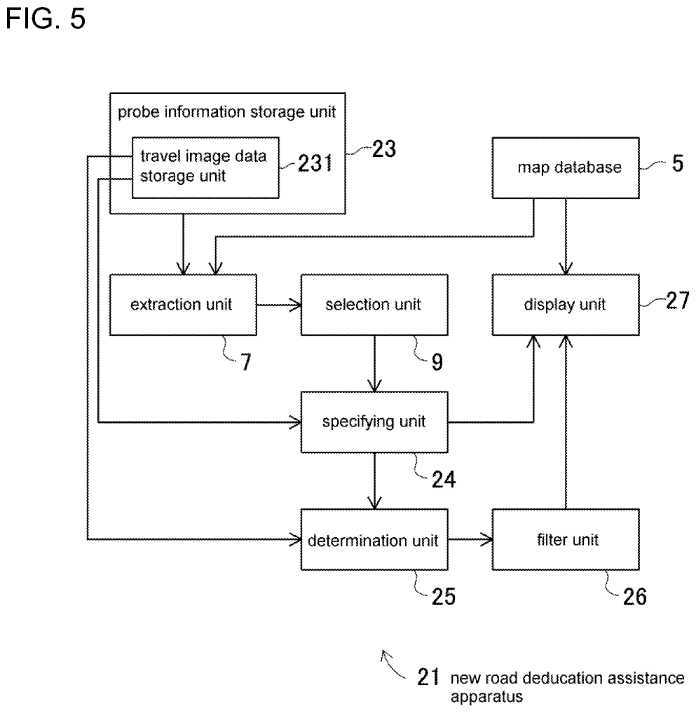

FIG. 5 is a block diagram schematically showing a configuration of a new road deducation assistance apparatus, according to a second embodiment of the present invention;

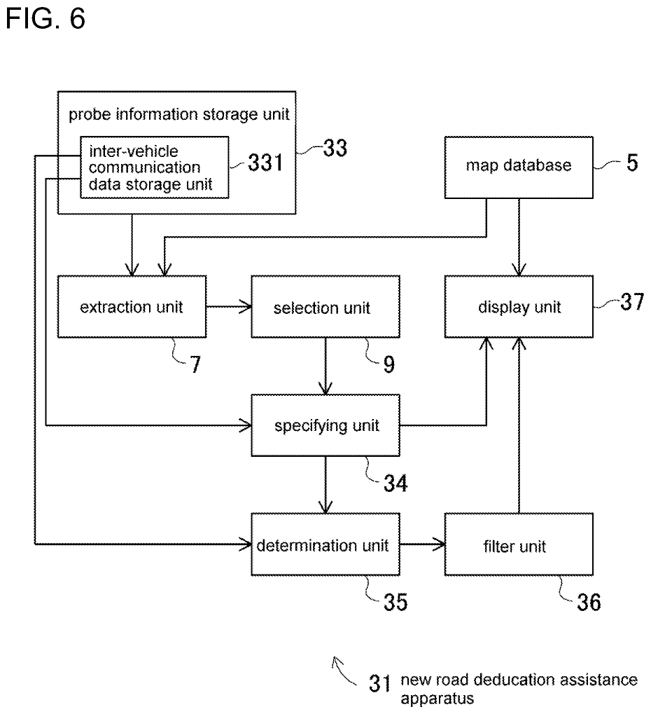

FIG. 6 is a block diagram schematically showing a configuration of a new road deducation assistance apparatus, according to a third embodiment of the present invention;

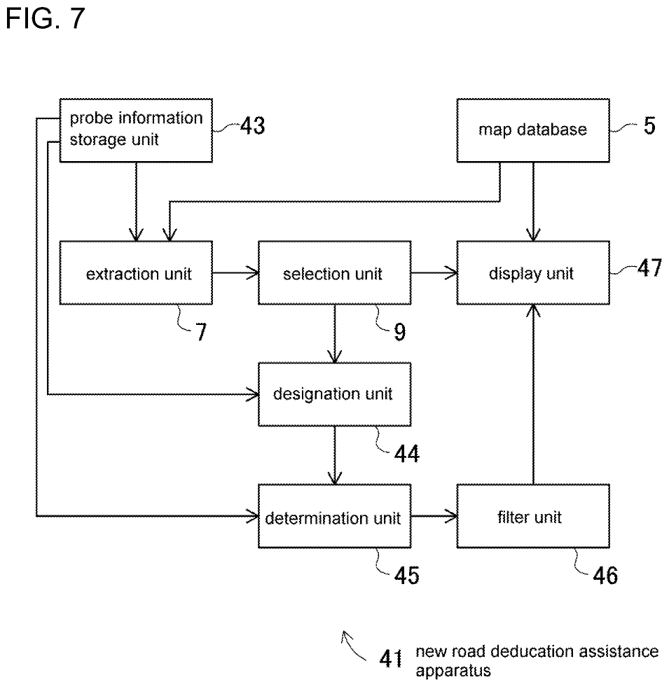

FIG. 7 is a block diagram schematically showing a configuration of a new road deducation assistance apparatus, according to a fourth embodiment of the present invention;

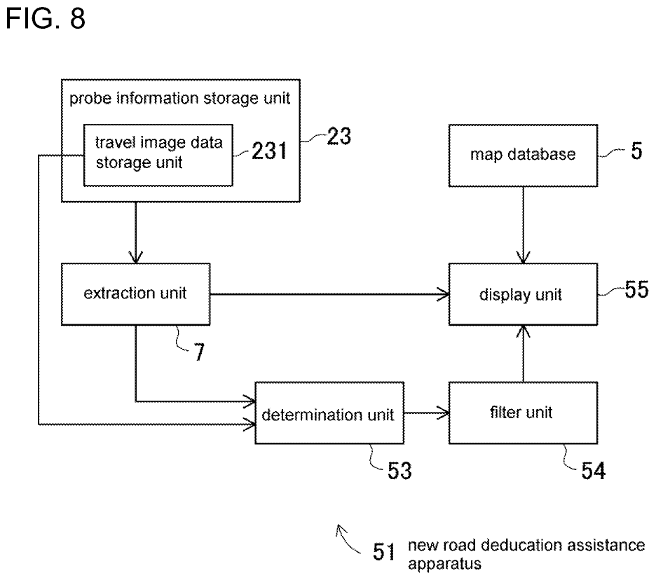

FIG. 8 is a block diagram schematically showing a configuration of a new road deducation assistance apparatus, according to a fifth embodiment of the present invention;

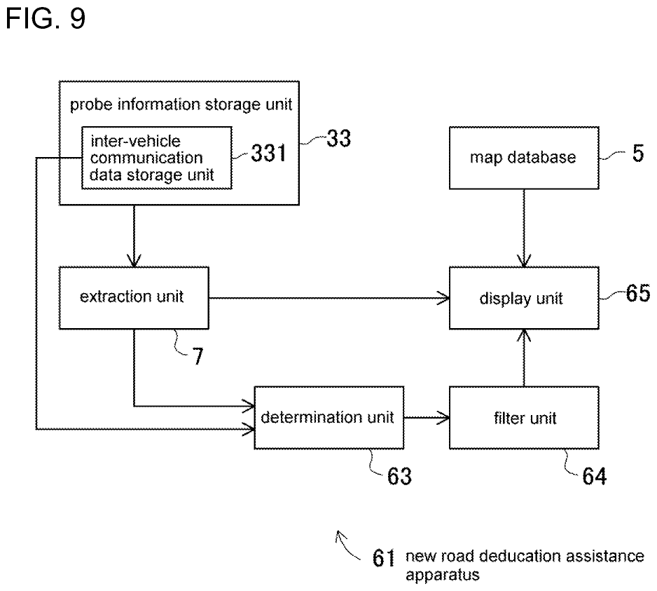

FIG. 9 is a block diagram schematically showing a configuration of a new road deducation assistance apparatus, according to a sixth embodiment of the present invention;

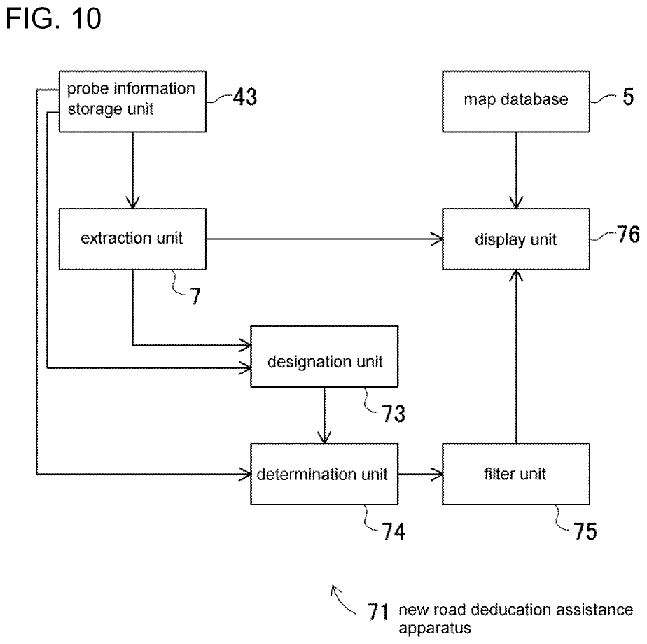

FIG. 10 is a block diagram schematically showing a configuration of a new road deducation assistance apparatus, according to a seventh embodiment of the present invention; and

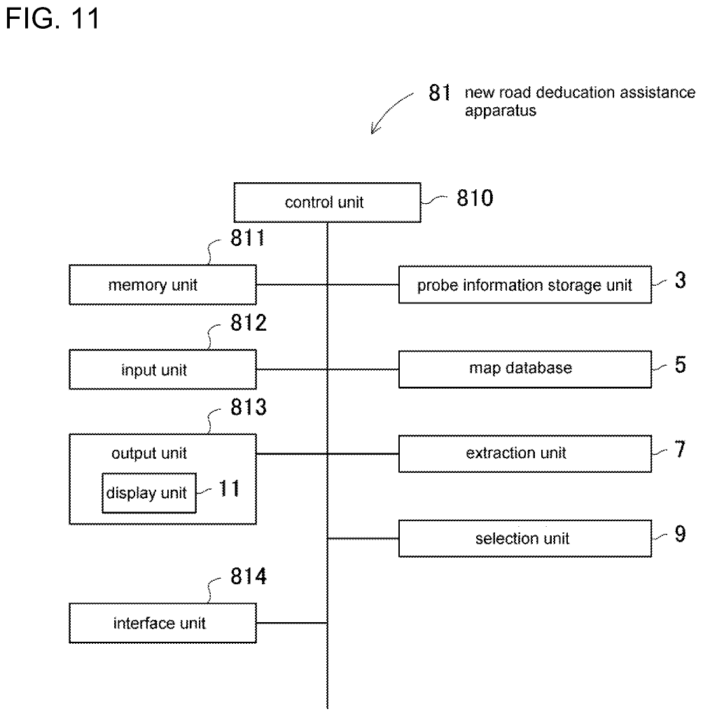

FIG. 11 is a block diagram schematically showing a configuration of a new road deducation assistance apparatus, according to a first example of the present invention.

### DETAILED DESCRIPTION

Several embodiments and examples of the present disclosure are described below with reference to the accompanying drawings.

### First Embodiment

FIG. 1 is a block diagram schematically showing a configuration of a new road deducation assistance apparatus 1 according to an embodiment of the present invention. The following description will be made with reference to the schematic diagram shown in FIG. 3.

As shown in FIG. 1, the new road deducation assistance apparatus 1 of the first embodiment includes a probe information storage unit 3, a map database 5, an extraction unit 7, a selection unit 9, and a display unit 11.

The probe information storage unit 3 stores probe information pieces acquired from a terminal device mountable on a vehicle and having a position information acquisition function, and the probe information pieces include position information and date/time information of the terminal device and terminal ID information capable of identifying the terminal device. The terminal device mountable on the vehicle is not particularly limited as long as position information and date/time information of the terminal device can be acquired, and is not limited to an in-vehicle navigation device or in-vehicle terminal device, but may be a portable communication terminal device, such as a mobile phone, a PDA (Portable Digital Assistants), a mobile game machine, a notebook PC, a PND (Portable Navigation Device), a smartphone, a wearable device which can be mounted on a human body. The probe information storage unit 3 may store other pieces of probe information pieces, such as velocity information, azimuth information, altitude information, and acquisition interval information of position information.

The map database 5 stores map data. The map data includes information relating to road elements for defining map information such as links and nodes, and information drawn on a two-dimensional map or a three-dimensional map such as structures. The map data may be stored, for example, as point group data or image data obtained by a laser scanner.

Among the probe information pieces stored in the probe information storage unit 3, the extraction unit 7 extracts, as target probe information pieces, probe information pieces which are not matched with the links stored in the map database 5 and whose velocity information indicates a predetermined value or more. For example, The extraction unit 7 extracts, as “probe information pieces which are not matched with the links”, probe information pieces located outside the links from the probe information pieces stored in the probe information storage unit 3 based on the position information of the probe information pieces and the link coordinate information. Further, as “probe information pieces whose velocity information indicates a predetermined value or more”, probe information pieces whose velocity information indicates a predetermined value or more (for example, 50 km/h or more) are extracted from the probe information pieces stored in the probe information storage unit 3. The velocity information may be changed depending on the road type of the new road to be deduced. For example, the velocity can be 50 km/h or more and 70 km/h or less when a general road is to be deduced as a new road, and 80 km/h or more when a highway is to be deduced. When the probe information pieces stored in the probe information storage unit 3 include velocity information, the velocity information can be used as the velocity information used in the extraction. As another example, velocity information calculated based on position information and date/time information of two or more pieces of probe information having the same terminal ID information may be used. The extraction unit 7 may extract “probe information pieces whose velocity information indicates a predetermined value or more” from the “probe information pieces which are not matched with the links” after extracting the “probe information pieces which are not matched with the links” or may extract “probe information pieces which are not matched with the links” from the “probe information pieces whose velocity information indicates a predetermined value or more” after extracting the “probe information pieces whose velocity information indicates a predetermined value or more” in the reverse order.

The selection unit 9 selects, from the target probe information pieces extracted by the extraction unit 7, a group of the target probe information pieces having the same terminal ID information and having a predetermined number or more of target probe information pieces being continuous in time. For example, the selection unit 9 specifies target probe information pieces having the same terminal ID information of the extracted target probe information pieces as the “target probe information pieces having the same terminal ID information”, and selects, from “target probe information pieces having the same terminal ID information”, a group of the target probe information pieces as “target probe information pieces being continuous in time” when the number of the target probe information pieces having continuous date/time information of the target probe information pieces is a predetermined number or more (for example, 10 or more). Whether or not the date/time information of the target probe information pieces having the same terminal ID information is continuous can be determined, for example, by determining that the target probe information pieces exist within the predetermined time interval (for example, within 3 seconds). When the probe information pieces stored in the probe information storage unit 3 include acquisition interval information of position information, it can be determined that the target probe information pieces are continuous in time when the target probe information pieces exist at every acquisition interval. As another example, the acquisition interval information can be deduced from the date/time information of other target probe information pieces having the same terminal ID information, and when the target probe information pieces exist at every deduced acquisition interval, it can be determined that the target probe information pieces are continuous in time. In addition, when the velocity information and the acquisition interval information of the position information are stored in the probe information storage unit 3, the selection unit 9 can determine the predetermined number based on the velocity information and the acquisition interval information of the probe information pieces. For example, it is preferable that the number of the continuous target probe information pieces is such that the travel distance from the start point to the end point of the continuous target probe information pieces is a predetermined distance or more (for example, 100 m or more). That is, the shorter the acquisition interval of the target probe information pieces, the more target probe information pieces are preferably continuous. Specifically, in a case that the acquisition interval is 1 second and the velocity is 50 km/h, when 8 pieces of target probe information pieces are continuous as the predetermined number, the continuous target probe information pieces can be selected as the group of the target probe information pieces. The predetermined distance relating to the travel distance may vary depending on the road type of the new road.

The display unit 11 superimposes and displays the group of the target probe information pieces selected by the selection unit 9 on the map information.

FIG. 2 is a flowchart showing an example of a new road deducation assistance method implemented by the new road deducation assistance apparatus 1 shown in FIG. 1.

In step 1, the extraction unit 7 refers to the map database 5 and extracts probe information pieces which are not matched with the links from the probe information storage unit 3. FIG. 3 (A) is a plot of the probe information pieces extracted in step 1 on a map.

In step 3, the extraction unit 7 extracts, as target probe information pieces, probe information pieces whose velocity information indicates 50 km/h or more from the probe information pieces extracted in step 1. FIG. 3 (B) is a plot of the probe information pieces extracted in step 3 on a map.

In step 5, the selection unit 9 selects target probe information pieces having the same terminal ID information from the target probe information pieces extracted in step 3.

In step 7, the selection unit 9 selects target probe information pieces being continuous in time from the target probe information pieces having the same terminal ID information selected in step 5. In step 7, for example, when the time interval between adjacent target probe information pieces of the target probe information pieces selected in step 5 is 3 seconds or less, it can be determined that the target probe information pieces are continuous in time.

In step 9, when the number of time-continuous target probe information pieces selected in step 7 is 8 or more (step 9: Yes), the selection unit 9 selects the plurality of target probe information pieces as the group of the target probe information pieces (step 11).

In step 13, the display unit 11 superimposes and displays the group of the target probe information pieces selected in step 11 so as to align with the coordinates on the map. FIG. 3 (C) is a plot of the group of the target probe information pieces selected in step 9 on a map. At the bottom right in FIG. 3 (C), the group of the target probe information pieces are plotted at a position on the map where no road exists. FIGS. 4 (A) to (C) are plots of a group of the target probe information pieces on a map satisfying the above conditions for another example. In any of these drawings, since there is a high possibility that a new road has been opened at a location where the group of the target probe information pieces indicated by dots are located, it is possible to specify the location as a target for a field survey or the like.

### Second Embodiment

FIG. 5 is a block diagram schematically showing a configuration of a new road deducation assistance apparatus 21 according to an embodiment of the present invention.

As shown in FIG. 5, the new road deducation assistance apparatus 21 of the second embodiment further includes a specifying unit 24, a determination unit 25, and a filter unit 26 in addition to the respective components of the new road deducation assistance apparatus 1 of the first embodiment, and a probe information storage unit 23 and a display unit 27 in place of the probe information storage unit 3 and the display unit 11. In FIG. 5, the same components as those in FIG. 1 are denoted by the same reference numerals, and the description thereof is partially omitted.

The probe information storage unit 23 includes a travel image data storage unit 231 in addition to the probe information storage unit 3 for storing the probe information pieces.

The travel image data storage unit 231 stores travel image data, and the travel image data is associated with all or part of the probe information pieces. That is, some of the probe information pieces may not be associated with the travel image data. The travel image data includes, for example, travel image data acquired by a vehicle-mounted camera provided so as to be capable of capturing images of the outside of a vehicle, that is, a road, a parking lot, and a surrounding vehicle. These travel image data are associated with position information and/or date/time information obtained along with the travel image data. As another example, these travel image data may be directly associated with the probe information pieces.

The specifying unit 24 refers to the travel image data storage unit 231 to specify the group of the target probe information pieces associated with the travel image data among the group of the target probe information pieces selected by the selection unit 9. The specifying unit 24 may specify the group of the target probe information pieces when the travel image data is associated with all target probe information pieces in the group of the target probe information pieces, or as another example, may specify the group of the target probe information pieces when the travel image data is associated with at least one target probe information piece in the group of the target probe information pieces. The target probe information pieces may be “associate with travel image data” when the target probe information pieces are directly associated with the travel image data, and as another example, the target probe information pieces may be associated with the travel image data by the presence of travel image data including position information and/or date/time information corresponding to the position information and/or date/time information of the target probe information pieces.

The determination unit 25 determines whether or not another vehicle has stopped in the vicinity of the specified group of the target probe information pieces, based on the travel image data associated with the group of the target probe information pieces specified by the specifying unit 24. The determination unit 25 refers to a travel image data storage unit 231, specifies travel image data associated with at least one target probe information piece constituting the specified group of the target probe information pieces, determines whether or not another vehicle exists in the vicinity of the target probe information pieces with respect to the specified travel image data, and determines whether or not the other vehicle is located in a parking area, and determines that the other vehicle has stopped in the vicinity of the specified group of the target probe information pieces when the other vehicle is located in a parking area. In order to improve the accuracy of the determination, the determination may be made when the number of other vehicles located in the parking lot is a predetermined number or more (for example, three or more). “Whether another vehicle exists in the vicinity of the target probe information pieces” can be determined based on the travel image data by the fact that the ratio of the other vehicle to the travel image data is a predetermined ratio or more (for example, 50% or more), or the distance from the target probe information pieces calculated from the ratio is a predetermined distance or less (for example, 10 m or less), for example.

The filter unit 26 removes the specified group of the target probe information pieces for which the determination unit 25 determines that the other vehicle has stopped. The filter unit 26 can perform processing such as providing a flag indicating that the determined group of the target probe information pieces are to be removed.

The display unit 27 superimposes and displays the group of the target probe information pieces specified by the specifying unit 24 on the map information except for the group of the target probe information pieces to which the removal flag is given by the filter unit 26.

### Third Embodiment

FIG. 6 is a block diagram schematically showing a configuration of a new road deducation assistance apparatus 31 according to an embodiment of the present invention.

As shown in FIG. 6, the new road deducation assistance apparatus 31 of the third embodiment further includes a specifying unit 34, a determination unit 35, and a filter unit 36 in addition to the respective components of the new road deducation assistance apparatus 1 of the first embodiment, and a probe information storage unit 33 and a display unit 37 in place of the probe information storage unit 3 and the display unit 11. In FIG. 6, the same components as those in FIGS. 1 and 5 are denoted by the same reference numerals, and the description thereof is partially omitted.

The probe information storage unit 33 includes an inter-vehicle communication data storage unit 331 in addition to the probe information storage unit 3 for storing the probe information pieces.

The inter-vehicle communication data storage unit 331 stores inter-vehicle communication data, which is associated with all or part of the probe information pieces. That is, some probe information pieces may not be associated with inter-vehicle communication data. The inter-vehicle communication data includes, for example, communication data in which information capable of determining whether another vehicle has stopped, such as velocity information and ignition information of the other vehicle located in the vicinity of the vehicle, is associated with position information and/or date/time information of the other vehicle. These inter-vehicle communication data are associated with position information and/or date/time information obtained along with the inter-vehicle communication data. As another example, these inter-vehicle communication data may be directly associated with the probe information pieces.

The specifying unit 34 refers to the inter-vehicle communication data storage unit 331 to specify the group of the target probe information pieces associated with the inter-vehicle communication data among the group of the target probe information pieces selected by the selection unit 9. Similar to the specifying unit 24, the specifying unit 34 can specify the group of the target probe information pieces when inter-vehicle communication data is associated with all target probe information pieces in the group of the target probe information pieces or when inter-vehicle communication data is associated with at least one target probe information piece in the group of the target probe information pieces. As described above, the target probe information pieces may be “associate with inter-vehicle communication data”, when the target probe information pieces are directly associated with inter-vehicle communication data, or the target probe information pieces may be associated with inter-vehicle communication data by the presence of inter-vehicle communication data including position information and/or date/time information corresponding to position information and/or date/time information of the target probe information pieces.

The determination unit 35 determines whether or not another vehicle has stopped in the vicinity of the specified group of the target probe information pieces, based on the inter-vehicle communication data associated with the group of the target probe information pieces specified by the specifying unit 34. The determination unit 35 refers to the inter-vehicle communication data storage unit 331, specifies the inter-vehicle communication data associated with at least one target probe information piece constituting the specified group of the target probe information pieces, determines whether or not another vehicle exists in the vicinity of the target probe information pieces and whether or not the velocity information of the other vehicle indicates zero or the ignition is off, and determines that the other vehicle has stopped in the vicinity of the specified group of the target probe information pieces when the velocity information of the other vehicle is zero or the ignition is off. In order to improve the accuracy of the determination, the determination may be made when the number of other vehicles in which the velocity information indicates zero or the ignition is off is a predetermined number or more (for example, three or more). “Whether another vehicle exists in the vicinity of the target probe information pieces” can be determined based on the inter-vehicle communication data by the fact that the position of the other vehicle is within a predetermined distance (for example, within 10 m) from the location indicated by the target probe information pieces or the group of the target probe information pieces. Further, when a predetermined percentage of the vehicles having inter-vehicle communication data are stopped, it may be determined that the other vehicles in the vicinity of the target probe information pieces are stopped.

The filter unit 36 removes the specified group of the target probe information pieces for which the determination unit 35 determines that the other vehicle has stopped. The removal method can be performed in the same manner as in the filter unit 26.

The display unit 37 superimposes and displays the group of the target probe information pieces specified by the specifying unit 34 on the map information except for the group of the target probe information pieces to which the removal flag is given by the filter unit 36.

### Fourth Embodiment

FIG. 7 is a block diagram schematically showing a configuration of a new road deducation assistance apparatus 41 according to an embodiment of the present invention.

As shown in FIG. 7, the new road deducation assistance apparatus 41 of the fourth embodiment further includes a designation unit 44, a determination unit 45, and a filter unit 46 in addition to the respective components of the new road deducation assistance apparatus) of the first embodiment, and a probe information storage unit 43 and a display unit 47 in place of the probe information storage unit 3 and the display unit 11. In FIG. 7, the same components as those in FIGS. 1, 5, and 6 are denoted by the same reference numerals, and the description thereof will be partially omitted.

The probe information storage unit 43 stores velocity information in addition to probe information pieces stored in the probe information storage unit 3.

The designation unit 44 refers to the probe information storage unit 43 and designates probe information pieces of another vehicle which exists at the same time as and in the vicinity of the group of the target probe information pieces selected by the selection unit 9. The designation unit 44 may designate, for all target probe information pieces in the group of the target probe information pieces, probe information pieces of another vehicle present at the same time in the vicinity of the target probe information pieces, or may specify, for at least one target probe information piece in the group of the target probe information pieces, probe information pieces of another vehicle present at the same time in the vicinity of the target probe information pieces. Whether or not the other vehicle exists at the same time in the vicinity of the target probe information pieces can be determined by the fact that the position of the other vehicle is within a predetermined distance (for example, within 50 m) from the location indicated by the target probe information pieces or the group of the target probe information pieces, and the fact that the date/time information of the probe information pieces of the other vehicle is within a predetermined time (for example, within 10 minutes) of the date/time information of the target probe information pieces. As another example, the determination may be made on the basis that the date/time information of the other vehicle is included in a range from a predetermined time before the start point of the group of the target probe information pieces (for example, 10 minutes before) to a predetermined time after the end point (for example, 10 minutes after).

The determination unit 45 determines whether the other vehicle has stopped based on the velocity information of the probe information pieces designated by the designation unit 44. The determination unit 45 can determine that the other vehicle has stopped when the velocity information of the other vehicle is zero. Furthermore, in place of or in addition to the velocity information, the ignition information of the probe information pieces may be referred to determine that the other vehicle has stopped when the ignition is off.

The filter unit 46 removes the selected group of the target probe information pieces for which the determination unit 45 determines that the other vehicle has stopped. The removal method can be performed in the same manner as in the filter unit 26.

The display unit 47 superimposes and displays the group of the target probe information pieces selected by the selection unit 9 on the map information except for the group of the target probe information pieces to which the removal flag is given by the filter unit 46.

### Fifth Embodiment

FIG. 8 is a block diagram schematically showing a configuration of a new road deducation assistance apparatus 51 according to an embodiment of the present invention.

As shown in FIG. 8, the new road deducation assistance apparatus 51 of the fifth embodiment includes a probe information storage unit 23, a map database 5, an extraction unit 7, a determination unit 53, a filter unit 54, and a display unit 55. In FIG. 8, the same components as those in FIGS. 1, 5, 6, and 7 are denoted by the same reference numerals, and a description thereof will be partially omitted.

The determination unit 53 determines, based on the travel image data associated with the target probe information pieces extracted by the extraction unit 7, whether or not the other vehicle has stopped in the vicinity of the extracted target probe information pieces. The determination unit 53 refers to the travel image data storage unit 231, specifies the travel image data associated with the extracted target probe information pieces, and determines, with respect to the specified travel image data, whether or not the other vehicle has stopped in the vicinity of the target probe information pieces. The determination can be performed in the same manner as in the determination unit 25.

The filter unit 54 removes the specified target probe information pieces for which the determination unit 53 determines that the other vehicle has stopped. The removal method is not particularly limited but can be executed by adding a removal flag or the like to the specified target probe information pieces in the same manner as in the filter unit 26.

The display unit 55 superimposes and displays the target probe information pieces extracted by the extraction unit 7 on the map information except for the target probe information pieces to which the removal flag is given by the filter unit 54.

### Sixth Embodiment

FIG. 9 is a block diagram schematically showing a configuration of a new road deducation assistance apparatus 61 according to an embodiment of the present invention. As shown in FIG. 9, the new road deducation assistance apparatus 61 of the embodiment 6 includes a probe information storage unit 33, a map database 5, an extraction unit 7, a determination unit 63, a filter unit 64, and a display unit 65. In FIG. 9, the same components as those in FIGS. 1, 5, 6, 7, and 8 are denoted by the same reference numerals, and description thereof will be partially omitted.

The determination unit 63 determines, based on the inter-vehicle communication data associated with the target probe information pieces extracted by the extraction unit 7, whether or not the other vehicle has stopped in the vicinity of the extracted target probe information pieces. The determination unit 63 refers to the inter-vehicle communication data storage unit 331, specifies the inter-vehicle communication data associated with the extracted target probe information pieces, and determines whether or not another vehicle exists in the vicinity of the target probe information pieces with respect to the specified inter-vehicle communication data. The determination can be performed in the same manner as in the determination unit 35.

The filter unit 64 removes the specified target probe information pieces for which the determination unit 63 determines that the other vehicle has stopped. The removal method can be performed in the same manner as in the filter unit 26.

The display unit 65 superimposes and displays the target probe information pieces extracted by the extraction unit 7 on the map information except for the target probe information pieces to which the removal flag is given by the filter unit 64.

### Seventh Embodiment

FIG. 10 is a block diagram schematically showing a configuration of a new road deducation assistance apparatus 71 according to an embodiment of the present invention.

As shown in FIG. 10, the new road deducation assistance apparatus 71 of the embodiment 7 includes a probe information storage unit 43, a map database 5, an extraction unit 7, a designation unit 73, a determination unit 74, a filter unit 75, and a display unit 76. In FIG. 10, the same components as those in FIGS. 1, 5, 6, 7, 8, and 9 are denoted by the same reference numerals, and the description thereof is partially omitted.

The designation unit 73 refers to the probe information storage unit 43 and designates probe information pieces of another vehicle which exists at the same time in the vicinity of the target probe information pieces extracted by the extraction unit 7. The designation method may be performed in the same manner as in the designation unit 44.

The determination unit 74 determines whether the other vehicle has stopped based on the velocity information of the probe information pieces specified by the designation unit 73. The determination can be performed in the same manner as in the determination unit 45.

The filter unit 75 removes the extracted target probe information pieces determined by the determination unit 74 that the other vehicle has stopped. The removal method can be performed in the same manner as in the filter unit 26.

The display unit 76 superimposes and displays the target probe information pieces extracted by the extraction unit 7 on the map information except for the target probe information pieces to which the removal flag is given by the filter unit 75.

### First Example

FIG. 11 is a block diagram schematically showing a configuration of a new road deducation assistance apparatus 81 as an example of embodiments of the present invention. The new road deducation assistance apparatus 81 of the first example includes a control unit 810, a memory unit 811, an input unit 812, an output unit 813, and an interface unit 814, in addition to the respective constituent elements constituting the new road deducation assistance apparatus 1 of the first embodiment. In FIG. 11, the same components as those in FIGS. 1, 5, 6, 7, 8, 9, and 10 are denoted by the same reference numerals, and the description thereof is partially omitted.

The control unit 810 is a computer device including a buffer memory and other devices, and controls other components constituting the new road deducation assistance apparatus 81.

The memory unit 811 stores a computer program and the computer program is read by the control unit 810, which is a computer device, to make it function. The computer program can be stored on a general-purpose medium such as an SD (registered trademark) memory card.

The input unit 812 is used, for example, for inputting an instruction of a user of the new road deducation assistance apparatus. As the input unit 812, a pointing device such as a mouse, a light pen, or a touch panel that cooperates with the display contents, a keyboard, or a voice input device such as a microphone may be used. For example, when the target probe information pieces are extracted by the extraction unit 7, it can be used to input the road type of the new road to be deduced and/or the velocity to be extracted.

The output unit 813 includes a display and can display the target probe extracted by the extraction unit 7 and the group of the target probe information pieces selected by the selection unit 9 together with a map. The output unit 813 includes a display unit 11. The function of the display unit 11 is as described above.

The interface unit 814 connects the new road deducation assistance apparatus 81 to a wireless network or the like.

In this specification, expressions such as “comprise”, “include”, or “have” of one component are intended to include other possible components, rather than being exclusive expressions intended to exclude the presence of other components.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

### REFERENCE SIGNS LIST

1, 21, 31, 41, 51, 61, 71, 81 new road deducation assistance apparatus
3, 23, 33, 43 probe information storage unit
5 map database (map DB)
7 extraction unit
9 selection unit
11, 27, 37, 47, 55, 65, 76 display unit
24, 34 specifying unit
25, 35, 45, 53, 63, 74 determination unit
26, 36, 46, 54, 64, 75 filter unit
44, 73 designation unit
231 travel image data storage unit
331 inter-vehicle communication data storage unit

1. A new road deducation assistance apparatus comprising:
a probe information storage unit for storing probe information pieces acquired from a terminal device mountable on a vehicle and having a position information acquisition function, the probe information pieces including position information and date/time information of the terminal device and terminal identification (ID) information capable of identifying the terminal device;
a map database for storing map information including information of links;
an extraction unit for extracting, from the probe information pieces stored in the probe information storage unit, probe information pieces which are not matched with the links and whose velocity information indicates a predetermined value or more as target probe information pieces;
a display unit for superimposing and displaying the extracted target probe information pieces on the map information; and
a selection unit for selecting, from the extracted target probe information pieces, a group of the target probe information pieces having the same terminal ID information and having a predetermined number or more of target probe information pieces being continuous in time, wherein the display unit superimposes and displays the selected group of the target probe information pieces on the map information.

2. The new road deducation assistance apparatus according to claim 1, wherein the probe information pieces further include information relating to an acquisition interval of the position information, and wherein the predetermined number is determined based on the acquisition interval information and the velocity information of the probe information pieces.

3. A new road deducation assistance apparatus according to claim 1, wherein all or part of the probe information pieces are associated with a travel image data, and the new road deducation assistance apparatus further comprises:
a specifying unit for specifying, from the selected group of the target probe information pieces, a group of the target probe information pieces associated with the travel image data;
a determination unit for determining, based on the travel image data associated with the group of the specified target probe information pieces, whether another vehicle has stopped in a vicinity of the group of the specified target probe information pieces; and
a filter unit for removing the group of the specified target probe information pieces for which it is determined that the other vehicle has stopped, wherein the display unit superimposes and displays the group of the specified target probe information pieces except for the group of the removed target probe information pieces.

4. The new road deducation assistance apparatus according to claim 1, wherein all or part of the probe information pieces are associated with an inter-vehicle communication data, and the new road deducation assistance apparatus further comprises:
a specifying unit for specifying, from the group of the selected target probe information pieces, a group of the target probe information pieces associated with the inter-vehicle communication data;
a determination unit for determining, based on the inter-vehicle communication data associated with the group of the specified target probe information pieces, whether another vehicle has stopped in a vicinity of the group of the specified target probe information pieces; and
a filter unit for removing the group of the specified target probe information pieces for which it is determined that the other vehicle has stopped, wherein the display unit superimposes and displays the group of the specified target probe information pieces except for the group of the removed target probe information pieces.

5. The new road deducation assistance apparatus according to claim 1, wherein the probe information pieces further include the velocity information, and the new road deducation assistance apparatus further comprises:
a designation unit for designating probe information pieces of another vehicle present at the same time in a vicinity of the group of the selected target probe information pieces;
a determination unit for determining whether the other vehicle has stopped based on the velocity information of the designated probe information pieces; and
a filter unit for removing the group of the selected target probe information pieces for which it is determined that the other vehicle has stopped, wherein the display unit superimposes and displays the selected group of the target probe information pieces except for the group of the removed target probe information pieces.

6. (canceled)

7. (canceled)

8. (canceled)

9. A new road deducation assistance method comprising:
storing, in a probe information storing unit, probe information pieces acquired from a terminal device mountable on a vehicle and having a position information acquisition function, the probe information pieces including position information and date/time information of the terminal device and terminal identification (ID) information capable of identifying the terminal device;
storing map information including information of links in a map database;
extracting, from the probe information pieces stored in the probe information storage unit, probe information pieces which are not matched with the links and whose velocity information indicates a predetermined value or more as target probe information pieces; and
superimposing and displaying the extracted target probe information pieces on the map information;
selecting, from the extracted target probe information pieces, a group of the target probe information pieces having the same terminal ID information and having a predetermined number or more of target probe information pieces being continuous in time, wherein in the displaying step, the group of the selected target probe information pieces are superimposed and displayed on the map information.

10. The new road deducation assistance method according to claim 9, wherein the probe information pieces further include information relating to an acquisition interval of the position information, and wherein the predetermined number is determined based on the acquisition interval information and the velocity information of the probe information pieces.

11. The new road deducation assistance method according to claim 9, wherein all or part of the probe information pieces are associated with a travel image data, and the new road deducation assistance method further comprises:
specifying, from the selected group of the target probe information pieces, a group of the target probe information pieces associated with the travel image data;
determining, based on the travel image data associated with the group of the specified target probe information pieces, whether another vehicle has stopped in the vicinity of the group of the specified target probe information pieces; and
removing the group of the specified target probe information pieces for which it is determined that the other vehicle has stopped, wherein, in the displaying step, the group of the specified target probe information pieces except for the group of the removed target probe information pieces are superimposed and displayed on the map information.

12. The new road deducation assistance method according to claim 9, wherein all or part of the probe information pieces are associated with an inter-vehicle communication data, and the new road deducation assistance method further comprises:
specifying, from the group of the selected target probe information pieces, a group of the target probe information pieces associated with the inter-vehicle communication data;
determining, based on the inter-vehicle communication data associated with the group of the specified target probe information pieces, whether another vehicle has stopped in a vicinity of the group of the specified target probe information pieces,
removing the specified group of the target probe information pieces determined that the other vehicle has stopped, and wherein, in the displaying step, the group of the specified target probe information pieces except for the group of the removed target probe information pieces are superimposed and displayed on the map information.

13. The new road deducation assistance method according to claim 9, wherein the probe information pieces further include the velocity information, and the new road deducation assistance method further comprises:
designating probe information pieces of another vehicle present at the same time in the vicinity of the group of the selected target probe information pieces;
determining whether the other vehicle has stopped based on the velocity information of the designated probe information pieces; and
removing the group of the selected target probe information pieces for which it is determined that the other vehicle has stopped, wherein, in the displaying step, the group of the selected target probe information pieces except for the group of the removed target probe information pieces are superimposed and displayed on the map information.

14. (canceled)

15. (canceled)

16. (canceled)

17. A computer program product comprising a computer readable hardware storage device having computer readable code stored therein, said program code executable by a processor of a computer system to implement a method for new road dedication assistance, the method comprising:
storing in a probe information storing unit, probe information pieces acquired from a terminal device mountable on a vehicle and having a position information acquisition function, the probe information pieces including position information and date/time information of the terminal device and terminal identification (ID) information capable of identifying the terminal device;
storing map information including information of links in a map database;
extracting, from the probe information pieces stored in the probe information storage unit, probe information pieces which are not matched with the links and whose velocity information indicates a predetermined value or more as target probe information pieces; and
superimposing and displaying the extracted target probe information pieces on the map information,
selecting, from the extracted target probe information pieces, a group of the target probe information pieces having the same terminal ID information and having a predetermined number or more of target probe information pieces being continuous in time, wherein the displaying means superimposes and displays the selected group of the target probe information pieces on the map information.

18. The computer program product according to claim 17, wherein the probe information pieces further include information relating to an acquisition interval of the position information, and wherein the predetermined number is determined based on the acquisition interval information and the velocity information of the probe information pieces.

19. The computer program product according to claim 17, wherein all or part of the probe information pieces are associated with a travel image data,
further comprising:
specifying, from the selected group of the target probe information pieces, a group of the target probe information pieces associated with the travel image data;
determining, based on the travel image data associated with the group of the specified target probe information pieces, whether another vehicle has stopped in a vicinity of the group of the specified target probe information pieces; and
removing the group of the specified target probe information pieces for which it is determined that the other vehicle has stopped, wherein the displaying means superimposes and displays the group of the specified target probe information pieces except for the group of the removed target probe information pieces.

20. The computer program according to claim 17, wherein all or part of the probe information pieces are associated with an inter-vehicle communication data,
further comprising:
specifying, from the group of the selected target probe information pieces, a group of the target probe information pieces associated with the inter-vehicle communication data;
determining, based on the inter-vehicle communication data associated with the group of the specified target probe information pieces, whether another vehicle has stopped in a vicinity of the group of the specified target probe information pieces; and
removing the group of the specified target probe information pieces for which it is determined that the other vehicle has stopped, wherein the displaying means superimposes and displays the group of the specified target probe information pieces except for the group of the removed target probe information pieces.

21. The computer program according to claim 17, wherein the probe information pieces further include the velocity information,
further comprising:
designating probe information pieces of another vehicle present at the same time in a vicinity of the group of the selected target probe information pieces;
determining whether the other vehicle has stopped based on the velocity information of the designated probe information pieces; and
removing the group of the selected target probe information pieces for which it is determined that the other vehicle has stopped, wherein the displaying means superimposes and displays the selected group of the target probe information pieces except for the group of the removed target probe information pieces.

22. (canceled)

23. (canceled)

24. (canceled)

25. (canceled)
